(19) United States
(12) Patent Application Publication
(10) Pub. No.: US 2007/0121109 A1
(43) Pub. Date: May 31, 2007

(54) Lens inspection

(76) Inventors: Roger Biel, Aschaffenburg (DE); Peter Hagmann, Erlenbach am Main (DE)

Correspondence Address: CIBA VISION CORPORATION;PATENT DEPARTMENT, 11460 JOHNS CREEK PARKWAY, DULUTH, GA, 30097-1556, US

(21) Appl. No.: 10/581,654

(22) PCT Filed: Dec. 3, 2003
(86) PCT No.: PCT/EP04/13783

§ 371 Date: Jun. 1, 2006

(30) Foreign Application Priority Data
Dec. 4, 2003 (EP) 03027940.0

(51) Int. Cl. G01N 21/88

(52) U.S. Cl. 356/239.2

(57) ABSTRACT

The invention relates to a method for the automatic inspection of tinted contact lenses, in an automatic lens manufacturing process. The method comprises the use of a dark-field inspection unit, which allows to effectively detecting cosmetic defects even in correspondence of the iris print.

The invention relates to a method for the automatic inspection of tinted contact lenses, in an automatic lens manufacturing process.

### BACKGROUND OF THE INVENTION

Nowadays tinted contact lenses are produced in highly automated production plants. Advantageously these contact lenses are formed using reusable mould halves, the female and the male, which normally consist of glass or quartz. When mated these mould halves define a hollow cavity, which corresponds to the subsequent contact lens shape. Before closing the mould halves, a polymer solution is dosed into the female mould half. After closing the mould halves, UV light is radiated over a mould half, which leads to crosslinking of the lens material. Subsequently, the lens is removed from the mould half for example with suction grips or mechanical grippers. The appropriate colouring may be applied on the area correspondent to the iris by means of any known technique for example by mould transfer or laser printing. Finally the lens is placed in the pack.

In order to assure constant quality of the contact lenses, provisions are in place for automatic inspection of the contact lenses using industrial image processing methods. Because of the coloured print in correspondence to the iris, the automatic inspection of tinted contact lenses is however particularly difficult and often the intervention of human inspection is necessary. More specifically, the commonly used inspection techniques based on bright-field imaging do not allow detecting all the cosmetic defects such as bubbles and tears in the area of the iris print. The iris print is in fact covering at least part of these defects rendering the inspection inaccurate and unreliable.

As a consequence, there is a need of providing an inspection device and an inspection method, which recognises the defective tinted lenses with a high degree of reliability, by effectively detecting cosmetic defects such as surface defects, tears, ruptures and inclusions such as bubbles and foreign bodies even in the area of the iris print.

### SUMMARY OF THE INVENTION

The present invention provides a method for the automatic inspection of tinted contact lenses, in an automatic lens manufacturing process. The method comprises the use of a dark-field imaging unit.

The essential principle of dark-field based inspection methods is that the direct light illuminating the specimen, in this case a contact lens, must not enter the objective lens of a camera. Only light that is scattered by the specimen is detected by the objective lens. This is achieved by using dark-field diaphragm stops or special dark-field substage condensers. Therefore if a specimen is completely free of structures scattering or refracting the light, a completely dark image is obtained. On the other hand, any structure scattering or refracting the light on the surface of the specimen or embedded in it, gives rise to a bright image of these details against a dark background. It is worth noting that features which absorb light, like an iris print on a contact lens are completely invisible in a dark-field image.

The method is particularly useful for inspecting soft opaque tinted contact lens wherein the term “opaque” is intended as blocking the passage of light.

In a particularly preferred embodiment the dark-field imaging inspection unit is based on the schlieren method.

In a further preferred embodiment a dark-field inspection unit may be used in combination with a bright-field inspection unit for a simultaneous inspection of tinted contact lenses.

Further details and advantages of the invention may be seen from the description and the drawings that follow.

### BRIEF DESCRIPTION OF THE FIGURES

FIG. 1 shows a schematic illustration of a dark-field inspection device according to the invention.

FIG. 2 shows an image of a tinted contact lens on a bright-field;

FIG. 3 shows an image of a tinted contact lens on a dark-field;

### DETAILED DESCRIPTION OF THE INVENTION

According to the present invention tinted contact lenses are inspected by an inspection device comprising a dark-field inspection unit.

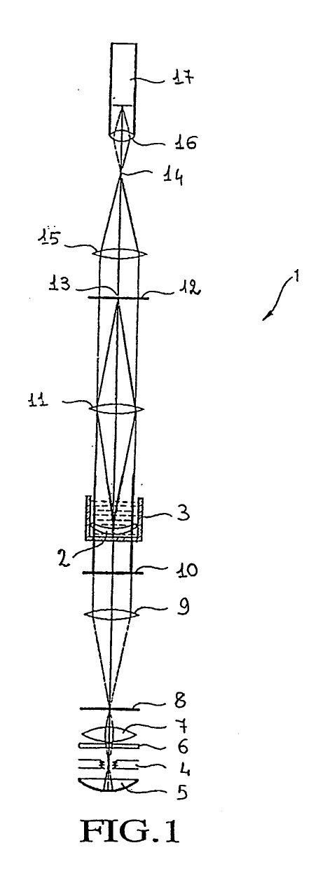

An inspection device 1 according to one embodiment of the invention is illustrated in FIG. 1 and consists of a single dark-field inspection unit. The tinted contact lens 2, which is preferably a soft one, is held in a container 3.

By an appropriate transport subsystem in the production plant, the container 3 is moved along a predetermined path into the lens inspection position wherein one lens at the time is inspected. Preferably the lens is continuously moving trough the inspection system, however the lens may also be in a stationary position during the inspection.

The container 3 is transparent at least at the bottom to allow the illumination beam coming from the light source to be transmitted trough the contact lens. The container 3 may be open at the top or closed by means of a transparent window. In use, the container 3 is partially filled with a fluid solution such as for example water or saline solution or a similar test liquid. Preferably, the shape of the container is such that, when a contact lens is placed in the container the container tends to centre the lens automatically therein at its bottom. The container may stand alone on the transport subsystem or may be part of a lens carrier provided to hold a multitude of containers.

The light source 4 to illuminate the contact lens may be any suitable kind of light source generating either a continuous illumination beam or a serious of flashes or pulses. In the last case the inspection system preferably further includes a synchronization or coordination mechanism between the transport subsystem and the light source which takes care that the light source is activated exactly when the contact lens is in the inspection position.

Examples of preferred light sources are halogen lamps, light emitting diodes or snort arc-xenon flash lamps. To increase the output of light, a concave mirror 5 may be used. The light reflected by the light source 4 and the concave mirror 5 is then focussed onto the input diaphragm 8 in a preferred embodiment by a heat filter 6 and a biconvex lens 7. This diaphragm 8 lies in the focus point of a further lens 9, so that the light emanating from the light source 4 is collimated and parallel light is present in the examining zone. It is also possible for an interference filter 10 to be additionally used behind the lens 9, in order to substantially increase the length of coherence of the light emanating from the light source 4.

For the illumination beam and the observation beam, achromatic lenses are preferably used, in order to avoid aberrations. Observation is preferably carried out under a small angle.

The illumination beam transmitted through the contact lens is incident on an imaging convex lens 11 and then on a beam stop 13 located in the focal plane 12 on the other side of the imaging lens 11. The beam stop 13 in the filter plane 12 should advantageously be of larger diameter than the input diaphragm 8, so that the illuminating part of the beam is fully scattered by the imaging properties of the contact lens 2 despite deviations in the illuminating beam. Of course, the beam stop 13 should not be too large, since otherwise too many low frequency parts are filtered out at this point. Finally, the deviation of the scattered beam is only small against the direction of the beam. Using computer-assisted simulation of the path of the beam and the confirmation from the experiments, with an input diaphragm 8 of 1 mm, the size of the beam stop 13 is advantageously 2-3 mm.

In the absence of scattering or refraction of illumination beam by the contact lens, no light is transmitted past the stop 13 and to the CCD camera 17, and the resulting picture is completely dark. However any feature of contact lens which deflects light enough to miss the stop 13 will cause some light to be incident on the pixel array of camera 17. In particular, an intermediate image 14 is taken by a lens 16 of camera 17.

By any known method in the art the image is automatically processed by a computer which decides whether to reject the lens or process it further according to preset selection criteria.

This dark-field method, characterized by the fact that the beam stop is positioned between the contact lens and the camera was introduced by A. Toepler to examine lenses and it is known in literature as “Schlieren method”. Schlieren systems are especially effective in detecting cosmetic defects such as surface defects, tears, ruptures and inclusions such as bubbles and foreign bodies.

However any other known dark-field method may be used. For instance, in alternative the beam stop might be positioned between the light source and the contact lens to be inspected.

Since the resulting dark-field image is not effected by any object in or within the lens which absorbs light such as an iris print this method turned out to be particularly effective to inspect tinted contact lens. Cosmetic defects which may be hidden by the iris print become clearly detectable.

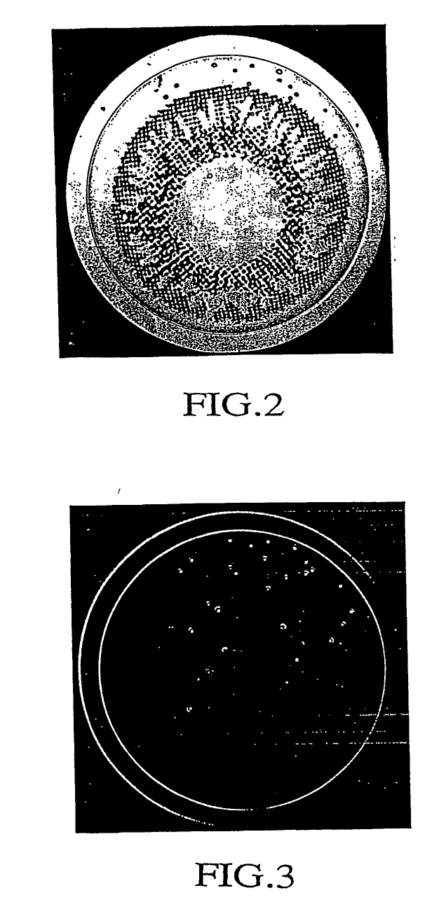

FIG. 2 shows a bright-field image of a tinted contact lens and FIG. 3 shows a dark-field image of the same lens. While the iris print is clearly visible in the bright-field image, it is completely invisible in the dark-field one, allowing the identification of all the defects even in the area correspondent to the iris print.

For an extensive and thorough inspection of tinted contact lenses a dark-field inspection unit of the type described above may be used in combination with a bright-field inspection unit which more easily recognizes linear surface defects outside the iris print. An example of how a simultaneous inspection of a contact lens may be obtained by combining a bright-field and a dark-field inspection unit is illustrated in EP 1248092 A1. There, past the container the illumination beam is divided by a beam-dividing cube. One beam is that formerly of the schlieren optics and the other beam is that given in transmitted light.

The methods described above are suitable to inspect any kind of tinted contact lenses. Preferably the contact lens is a soft contact lens for example a conventional hydrogel lens which comprises for example a poly-HEMA homo or copolymer, a PVA homo or copolymer, or a crosslinked polyethylenglycol or a polysiloxane hydrogel. In addition the lenses of the present invention have a coloured iris section which is composed of translucent and/or preferably opaque colour elements which form an iris print. Examples of iris prints are given in EP 498835 B, EP 972224 A1, EP 1062541 A1 and EP 1244933 A1.

1. The use of a dark-field inspection unit for the automatic inspection of a tinted contact lens.

2. The use of claim 1 wherein the dark-field inspection unit is based on the schlieren method.

3. The use of claim 1 wherein the dark-field inspection unit is combined with a bright-field inspection unit.

4. The use of claim 1 wherein the contact lens is an opaque tinted lens.
